(19) United States
(12) Patent Application Publication
(10) Pub. No.: US 2012/0252481 A1
(43) Pub. Date: Oct. 4, 2012

(54) MACHINE TO MACHINE COMMUNICATION IN A COMMUNICATION NETWORK

(75) Inventors: Sourabh ANPAT, London (GB); Nirav SALOT, Pune (IN)

(73) Assignee: CISCO TECHNOLOGY, INC., San Jose, CA (US)

(21) Appl. No.: 13/078,619

(22) Filed: Apr. 1, 2011

(51) Int. Cl. H04W 4/02; H04W 24/00

(52) U.S. Cl. 455/456.1

(57) ABSTRACT

This disclosure relates to a system and method for providing machine to machine communication in a communication network. Although machines are ever more capable of sensing and processing information, machines are expected to garner even more intelligence by autonomously communicating the sensed and processed information with other machines. Therefore, machine to machine (M2M) communication is emerging as an important application of a communication network. Despite the opportunity, accommodating a large number of machines in a communication network is a challenge for network operators. This disclosure provides systems and methods for efficiently accommodating M2M communication in a communication network.

### FIELD OF THE DISCLOSURE

This disclosure relates generally to a system and method for providing machine to machine communication in a communication network.

### BACKGROUND

Wireless networks are telecommunications networks that use radio waves to carry information from one node in the network to one or more receiving nodes in the network. Cellular telephony is characterized by the use of radio cells that provide radio coverage for a geographic area, with multiple cells arranged to provide contiguous radio coverage over a larger area. Wired communication can also be used in portions of a wireless network, such as between cells or access points.

Wireless communication technologies are used in connection with many applications, including, for example, satellite communications systems, portable digital assistants (PDAs), laptop computers, and mobile devices (e.g., cellular telephones, user equipment). Users of such applications can connect to a network (e.g., the Internet) as long as the user is within range of such a wireless communication technology. The range of the wireless communication technology can vary depending on the deployment. A macro cell transceiver is typically used by service providers to provide coverage over about a five kilometer distance. A pico cell transceiver can provide coverage over about a half kilometer distance, and a femto cell transceiver can provide coverage over a 50-200 meter distance. A femto cell transceiver is similar in coverage to a WiFi (WLAN) access point and can be used to provide network access over a short range.

### BRIEF DESCRIPTION OF THE DRAWINGS

FIG. 1 illustrates communication networks including a long term evolution (LTE) topology in accordance with some embodiments;

FIG. 2 is a flow diagram illustrating an initial attach procedure for a machine type communication (MTC) device in accordance with some embodiments;

FIG. 3 is a flow diagram illustrating how an MTC device enters an idle state in accordance with some embodiments;

FIG. 4 is a flow diagram illustrating how a network manages mobility information of an idle MTC device in accordance with some embodiments;

FIG. 5 is a flow diagram illustrating how an MTC server polls an MTC device to initiate data communication in accordance with some embodiments;

FIG. 6 illustrates a logical view of a mobility unit in accordance with certain embodiments;

FIG. 7 illustrates a network device in accordance with certain embodiments;

FIG. 8 illustrates a logical view of the software architecture of a network device in accordance with certain embodiments.

### DESCRIPTION OF EXAMPLE EMBODIMENTS

### Overview

Certain embodiments disclose a method of maintaining mobility information at a Mobility Management Entity (MME) in a communication network, wherein the MME is associated with at least one mobile device including a first mobile device and the mobility information includes mobility management context associated with the first mobile device. The method further comprises initiating a network session termination procedure to cause a release of resources associated with the first mobile device, and in response to a location update request message from the first mobile device, executing a location update procedure using the mobility information associated with the first mobile device and maintaining location information of the first mobile device. In addition, the method comprises receiving a paging trigger message initiated by an application server, wherein the paging trigger message includes an identification of the first mobile device to indicate that the first mobile device be paged; and sending a paging request message to the first mobile device to cause the first mobile device to attach to the communication network to accommodate data communication with the application server.

### Example Embodiments

The idea of an intelligent environment, in which machines automatically gather information, process information, and respond to information, is referred to as ubiquitous computing. Ubiquitous computing instantly became popular as a new computing paradigm because it introduced new applications of computation. For example, ubiquitous computing introduced a smart grid/smart metering application that automatically gauges an amount of electricity usage at a household; an eHealthCare system that senses patient's clinical data in real time and alerts doctors if the patient is experiencing fatal conditions; an automatic fleet tracking system that tracks location of fleets and updates the location of fleets at a centralized server; and automotive telematics that provisions toll payments and gas emissions.

One limitation in introducing an intelligent environment in a consumer realm is a lack of proper machine to machine (M2M) communication support in communication networks. M2M communication relates to an autonomous communication between two or more machines. M2M communication can provide an infrastructure for sharing and publishing information without explicit human intervention. M2M communication can use regular communication networks that target voice/data communication services, tailored to accommodating communication patterns often observed in voice/data communication. However, communication patterns observed in M2M communication can be substantially different from those of voice/data communication. In M2M communication, a mobile device, also known as a machine type communication (MTC) device, often moves within a small area and transmits a small amount of data at a time. When the MTC device is active or online, the MTC device can communicate with an application server, also known as an MTC server, at any point in time. But even when the MTC device is idle, the MTC device may still want to communicate with the MTC server at a predefined interval. The topology of M2M communication can be skewed: a large number of MTC devices may be connected to a single MTC server. These communication patterns are not necessarily observed in voice/data communication.

Accommodating burst-type M2M communication in a typical voice/data network can be challenging. In a communication network, a mobile device can communicate over the network (1) by initiating an initial attach procedure to attach to the network, and (2) by establishing an active Public Data Network (PDN) connection with the network after completing the initial attach procedure. The initial attach procedure can attach a mobile device to the network, whereas the PDN connection activation procedure can reserve network resources for the mobile device to provide communication. The network resources can include IP addresses, memory, and bandwidth in accordance with a quality of service (QoS). In the evolved packet system (EPS) of a Long Term Evolution (LTE) network, a mobile device executes an initial attach procedure and a Packet Data Protocol (PDP) context activation procedure simultaneously. Therefore, in the EPS, a mobile device is always connected to the network with dedicated core network resources and does not have an option of being connected to the network without dedicated network resources. This is true even if the mobile device is in an idle state. While such an always-on model can be beneficial for voice/data communication, the always-on model can be wasteful for M2M communication because most of the time the MTC devices would be idle. Furthermore, because a large number of MTC devices can take parts in M2M communication, accommodating active PDN connections for every MTC device would require that a large amount of resources be provisioned.

To address these challenges, the communication network can provide mobile devices with an option of being attached to the network without an active PDN connection and dedicated resources. This disclosure provides methods and systems for network devices in a communication network to provide such an option. In some embodiments, the communication network can provide additional features to an MTC device to emulate a state of being attached to the network without an active PDN connection and dedicated resources. For example, when the MTC device is not transmitting any data, the MTC device can enter an idle state. The idle state is a sleep mode state that can be used to conserve battery life of MTC device by turning off parts of the MTC device. When the MTC device enters an idle state, the communication network can release network resources dedicated to the MTC device, maintain the MTC device's context information, and track the location of the MTC device throughout the idle state. The communication network maintains such context information and location information so that a MTC server can poll the MTC device when the MTC server wants to communicate with the MTC device. This polling mechanism helps accommodate burst-type communication. This is different from how the communication network would treat a regular UE: if a regular UE enters an idle state, the communication would not release network resources dedicated to the UE, even if the UE is not actively utilizing the dedicated network resources.

Using the polling mechanism, the MTC server can poll the MTC device over the access network to set up a communication channel between the MTC server and the MTC device when the MTC server decides to communicate with the MTC device. This polling mechanism allows communication networks to allocate communication resources when data communication is needed and to release the resources once the data communication is completed, enabling an efficient use of communication resources. The polling mechanism can be implemented without extensive modifications to the network or MTC devices. For instance, in certain embodiments, an MTC server can poll an MTC device through a mobility unit, such as a mobility management entity (MME), by triggering the mobility unit to page the MTC device to initiate data communication. In this embodiment, the MTC device can be a traditional long-term evolution (LTE) UE, for instance a Rel-8 UE or a Rel-9 UE, which can be continuously attached to the network and provide accurate location information to the network. Also, in this embodiment, the SGW, PGW, or PCRF in the access network can be of a Rel-8 or a Rel-9 type without requiring any special functionality. Therefore, the polling mechanism can be implemented with simple modifications in the mobility unit and can be transparent to other network devices. The polling mechanism can also address a data congestion problem. Without the polling mechanism, all MTC devices can simultaneously transmit data to the MTC server, which may induce data congestion in the network and, possibly, network failure. However, if the MTC server polls the MTC devices to send data to the MTC server, the MTC server can control the number of MTC devices transmitting data to the MTC server, thereby circumventing problems associated with simultaneous data transmission. The polling mechanism can also provide a platform for scalable M2M communication: an increase in the number of MTC devices can be accommodated.

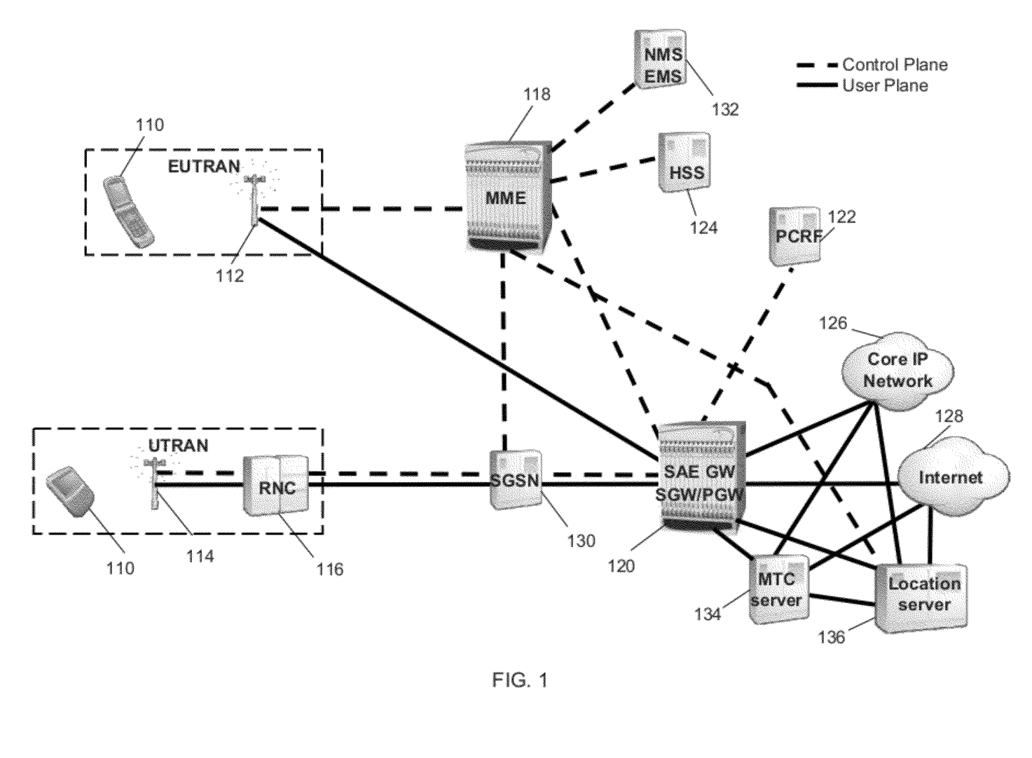

FIG. 1 illustrates a network diagram in accordance with certain embodiments. FIG. 1 illustrates a universal mobile telecommunication system (UMTS) release 8 network along with a LTE network. The network diagram of FIG. 1 includes user equipment (UE) 110, an evolved nodeB (eNB) 112, a nodeB 114, a radio network controller (RNC) 116, a mobility management entity (MME) 118, a system architecture evolution gateway (SAE GW) 120, a policy and charging rules function (PCRF) 122, home subscriber server (HSS) 124, core IP network 126, internet 128, Serving General packet radio service Support Node (SGSN) 130, network management system (NMS)/element management system (EMS) 132, a machine type communication (MTC) server 134, and a location server 136. The MME 118, SGSN 130, and SAE GW 120 can be implemented in a gateway as described below. The SAE GW 120 can include a serving gateway (SGW) as well as a packet data network gateway (PGW). In some embodiments, the SGW and PGW can be implemented on separate network devices. The main component of the SAE architecture is the Evolved Packet Core (EPC), also known as SAE Core. The EPC includes the MME, SGW and PGW components. The user equipment (UE) 110 can include a mobile phone, a laptop with wireless connectivity, a netbook, a smart phone, or any other wireless device, and can function as an MTC device.

MME 118 is a mobility unit residing in an LTE access network, controlling the operation of the LTE access network. The MME 118 is responsible for UE 110 tracking and paging procedures including retransmissions. The MME 118 handles the bearer activation/deactivation process, is responsible for choosing the SGW for a UE 110 at the initial attach and at time of an intra-LTE handover, authenticates the user by interacting with the HSS 124, generates and allocates temporary identities to UEs and terminates Non-Access Stratum (NAS) signaling, checks the authorization of the UE 110 to camp on the service provider's Public Land Mobile Network (PLMN), and enforces UE roaming restrictions. The MME 118 is the termination point in the network for ciphering/integrity protection for NAS signaling and handles the security key management. Lawful interception of signaling is also supported by the MME 118. The MME 118 provides the control plane function for mobility between LTE and 2G/3G access networks with an S3 interface terminating at the MME 118 from the SGSN 130. The MME 118 also terminates an S6a interface towards the home HSS for roaming UEs. In certain embodiments, the MME 118 can be enhanced to support the polling mechanism for M2M communication. The MME 118 could also be used in future “post-4G” wireless networks.

The SGW routes and forwards user data packets, while also acting as the mobility anchor for the user plane during inter-eNB handovers and as the anchor for mobility between LTE and other 3GPP technologies (terminating an S4 interface and relaying the traffic between 2G/3G systems and PDN GW). For idle state regular UEs, the SGW terminates the down link data path and triggers paging when down link data arrives for the UE 110. The SGW manages and stores UE contexts, e.g., parameters of the IP bearer service and network internal routing information. The SGW replicates user traffic in case of lawful interception. The PGW provides connectivity to the UE 110 to external packet data networks by being the point of exit and entry of traffic for the UE 110. A UE 110 may have simultaneous connectivity with more than one PGW for accessing multiple packet data networks. The PGW performs policy enforcement, packet filtering for each user, charging support, lawful interception, and packet screening. The PGW also provides an anchor for mobility between 3GPP and non-3GPP technologies such as WiMAX and 3GPP2 (CDMA 1× and EvDO).

The NMS/EMS 132 can provide management of the operation, administration, maintenance, and provisioning of networked system. Operation deals with keeping the network (and the services that the network provides) up and running smoothly, and includes monitoring to detect problems and minimize disruptions on the network. Administration deals with keeping track of resources in the network and how they are assigned. Maintenance is concerned with performing repairs and upgrades—for example, when equipment must be replaced, when a router needs a patch for an operating system image, when a new switch is added to a network. Provisioning is concerned with configuring resources in the network to support a given service. For example, this might include setting up the network so that a new customer can receive service. Functions that are performed as part of network management accordingly include controlling, planning, allocating, deploying, coordinating, and monitoring the resources of a network, network planning, frequency allocation, predetermined traffic routing to support load balancing, cryptographic key distribution authorization, configuration management, fault management, security management, performance management, bandwidth management, and accounting management. An element management system (EMS) has systems and applications that manage network elements (NE) on the network element management layer (NEL) of the Telecommunication Management Network model.

The UE 110 may be in an active state or an idle state. If the UE 100 is a regular UE, as opposed to an MTC device, the UE 100 can be always have dedicated network resources, even if the UE 100 is in the idle state. For a regular UE 110 in an idle state, the SGW can buffer IP packets received for the UE 100 and can initiate page requests towards the MME 118 or SGSN 130. If the UE 110 responds to the page, the SGW forwards the IP packet to the eNB in a LTE network or to a RNC/NB or RNC/BS in UMTS/general packet radio service (GPRS) for delivery to the UE 110.

In certain embodiments, an MTC server 134 and a location server 136 can reside on the opposite side of the core IP network 126 or the Internet 128. In other embodiments, an MTC server 134 and a location server 136 can reside in the access network. An MTC server 134 can host applications running on MTC devices. A location server 136 can utilize one or more positioning mechanisms to determine the location of a user entity or an MTC device. The positioning mechanisms can include measuring radio signals and estimating location using the measured signals. A location server 136 can (1) authenticate and authorize an MTC device, (2) manage mobility of network devices, (3) manage billing information, (4) broadcast messages to network devices, (5) coordinate radio signaling and location computation, and (6) maintain a binding information that indicates which MME is serving each MTC device. The binding information can be represented by associating the MTC device with the MME number and can be used for facilitating M2M communication. A location server 136 can communicate with an MME 118 using an interface. The interface between MME and location server can be based on SGs interface as specified in TS 29.118 of 3GPP. A location server 136 can be associated with an MTC server 134 to provide services to MTC devices. The location server 136 can communicate with the MTC server 134 over a communication channel. The location server 136 can be co-located with the MTC server 134 in a single box, or the location server 136 can be integrated into the MTC server 134 to provide an integrated service to MTC devices.

In certain embodiments, the network enhancement for M2M communication can be implemented on a mobility unit, such as MME 118. The mobility unit 118 can access and maintain information relating to the communication session, the subscriber, the radio bearers, and the policies relating to the communication session. The communication networks also allow provision of applications such as VoIP, streaming video, streaming music, multi-user gaming, location based services, and a variety of content delivered to a mobile device. Residing within the mobility unit 118 can be one or more network processing units, line cards, as well as control cards.

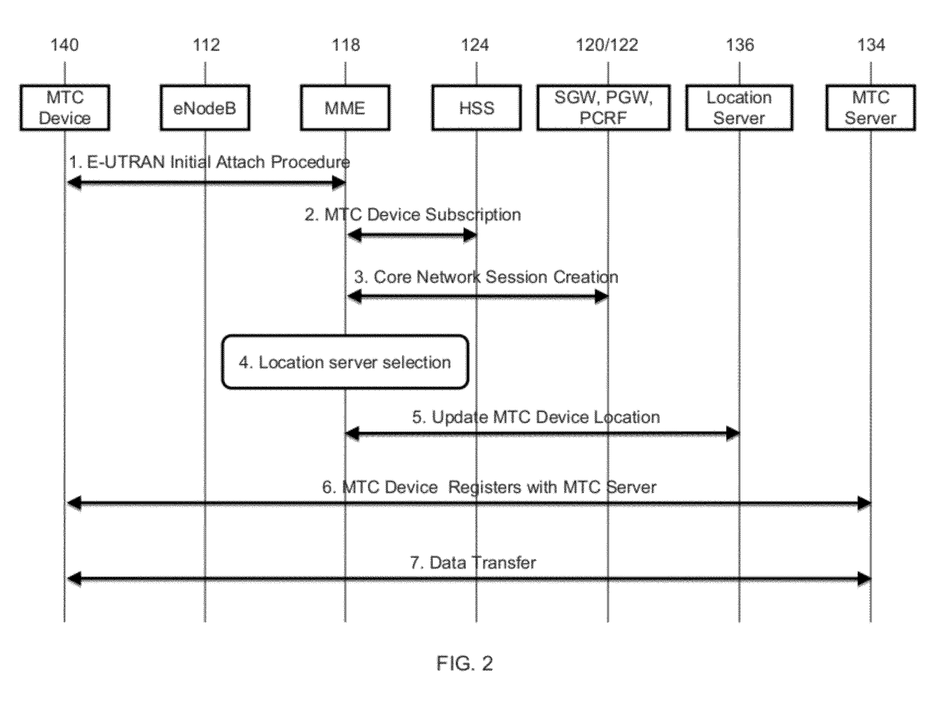

Communication networks can define a number of operations to accommodate M2M communication. In accordance with certain embodiments, FIGS. 2-5 show flow diagrams for (1) attaching an MTC device to the network, (2) sending an attached MTC device into an idle state, (3) managing mobility information of an idle MTC device, and (4) triggering data communication between an idle MTC device and an MTC server.

FIG. 2 shows a flow diagram of the initial attach procedure for an MTC device in accordance with certain embodiments. This procedure can create a session for the MTC device 140 and can initiate data communication, if needed. In step 1, the MTC device 140 powers up and initiates the E-UTRAN initial attach procedure. In this step, the MTC device 140 sends an initial attach message to the MME 118. In step 2, the MME 118 fetches MTC device subscription data from the HSS 124. In this step, the MME 118 can also recognize that the MTC device 140 is an MTC device type and flag the device as an MTC device type. This allows the MME 118 to provide appropriate services to the MTC device in accordance with MTC device information. The MTC device information can include subscription information, information received from the MTC device 140, and local policy implemented by the network operator. The MME 118 can recognize that a device is a MTC device type by analyzing (1) the initial attach message from the MTC device 140 and/or (2) the device subscription data retrieved from the HSS 124. The MTC device 140 includes a “machine type” indicator in the initial attach request message. The MME 118 can analyze this indicator to determine if the MTC device is a MTC device type. The MME 118 can maintain a tracking area update (TAU) timer for each user entity associated with the MME 118. When the TAU timer reaches a threshold, the MME 118 can initiate a TAU procedure for the corresponding mobile device. The movement of MTC devices can depend on applications of the MTC devices. Therefore, the TAU timer threshold can be set according to the applications of the MTC devices to reduce network resources dedicated to MTC device tracking. Lastly, the MME 118 can create a mobility management context, which includes an evolved packet system (EPS) mobility management (EMM) context. The EMM context can include information for determining the MTC device's location, authentication, confidentiality, and connection management.

In step 3, the access network creates a session for the MTC device 140. In particular, the MME 118, the SGW/PGW 120, and the PCRF 122 can (1) create an EPS session management (ESM) context for the MTC device 140, (2) allocate an IP address for the MTC device 140, and (3) reserve core network resources for the MTC device 140. In step 4, the MME 118 can select a location server 136 for the MTC device 140. The MME 118 has received the MTC device subscription data from the HSS 124 in step 2. Therefore, the MME 118 maintains sufficient information to select a location server 136 for the MTC device 140. The MME 118 can analyze applications running on the MTC device 140 to select an appropriate location server 136 to be associated with the MTC device 140. For instance, in certain embodiments, the MME 118 can use the subscription information, the MTC device's location information, and the locally configured policy to select an appropriate location server 136. In other embodiments, the MME 118 can query the DNS server serving the MTC device in order to select the location server 136. The MME 118 can locally configure the location server 136 based on the information available at the MME 118. In step 5, the MME 118 can send a message to cause the location server 136 to update the MTC device's location information on the location server 136. This allows the location server 136 to maintain up-to-date location information of each idle MTC device 140. In step 6, the MTC device 140 can register with the MTC server 134. The MTC server 134 can indicate that the MTC device 140 is “connected”, and update the IP address of the MTC device 140 in the MTC server's record. Step 6 can be carried out in parallel with step 5. In step 7, the MTC server 134 can poll the MTC device 140 to trigger data communication between the MTC device 140 and the MTC server 134.

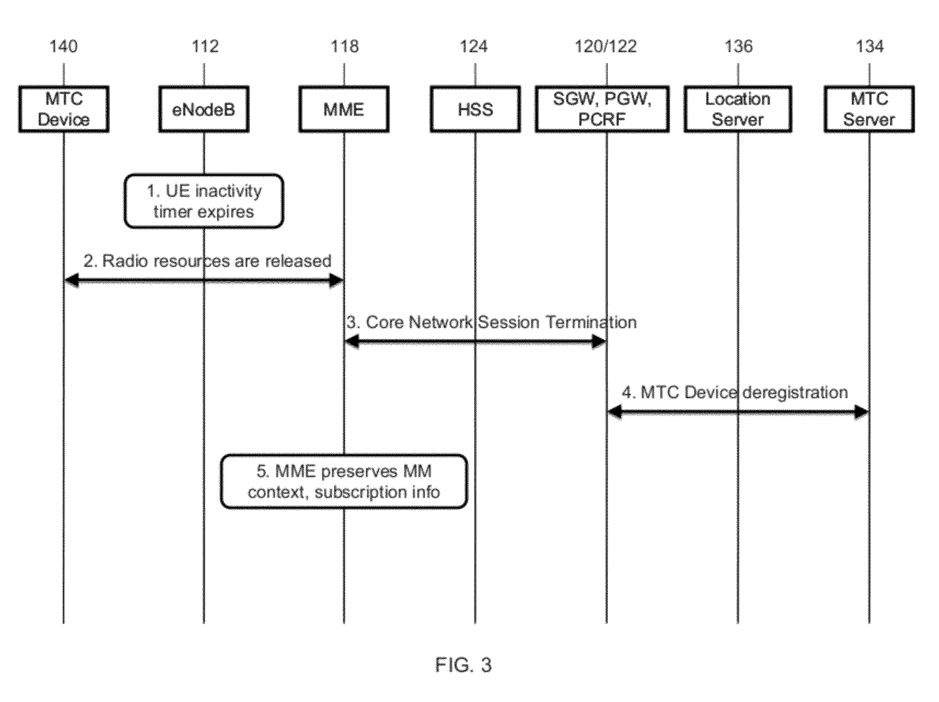

FIG. 3 shows a flow diagram for sending the MTC device into an idle state in accordance with certain embodiments. The eNodeB 112 keeps an UE inactivity timer to detect the end of the data communication between the MTC device 140 and the MTC server 134. When this UE inactivity timer expires, the eNodeB 112 can initiate a radio resource release procedure. In step 1 of FIG. 3, the eNodeB 112 detects that the UE inactivity timer is expired. Therefore, in step 2, the eNodeB 112 can release all the radio resources associated with the MTC device 140 including allocated radio frequencies and radio channels. In this step, the MME 118 can also release the S1 application protocol (S1AP) context, which can provide information related to the control plane signaling between the eNodeB 112 and the MME 118. In step 3, the MME 118 can initiate a procedure to detach the MTC device 140 from the core network nodes. In this step, the MME 118 can recognize that the MTC device 140 is of an MTC device type, and the MME 118 can initiate a network session termination procedure to trigger the SGW/PGW 120 and PCRF 122 to release all network resources associated with the MTC device 140. The network session termination procedure can terminate sessions associated with the MTC device 140 maintained by network devices in the communication network. When the PCRF 122 terminates the session for the MTC device 140, the MTC server 134 automatically de-registers the MTC device 140. Step 4 shows that the MTC server 134 can de-register the MTC device 140 in response to the termination of the MTC device session at the PCRF 122, and the MTC server 134 can further indicate that the MTC device 140 is “disconnected.”

In step 5, the MME 118 can maintain mobility information for the idle MTC device 140. The mobility information can include information for providing mobility to an MTC device 140, for example, informing the network of the MTC device's present location and providing an MTC device identity confidentiality. The mobility information can include the evolved mobility management (EMM) context and the subscription information. The mobility information can be stored in a memory such as a computer readable medium. With the mobility information, the MME 118 can support a location update procedure, including a tracking area update procedure, even if the MTC device 140 is in an idle state and no longer has any allocated radio and network resources.

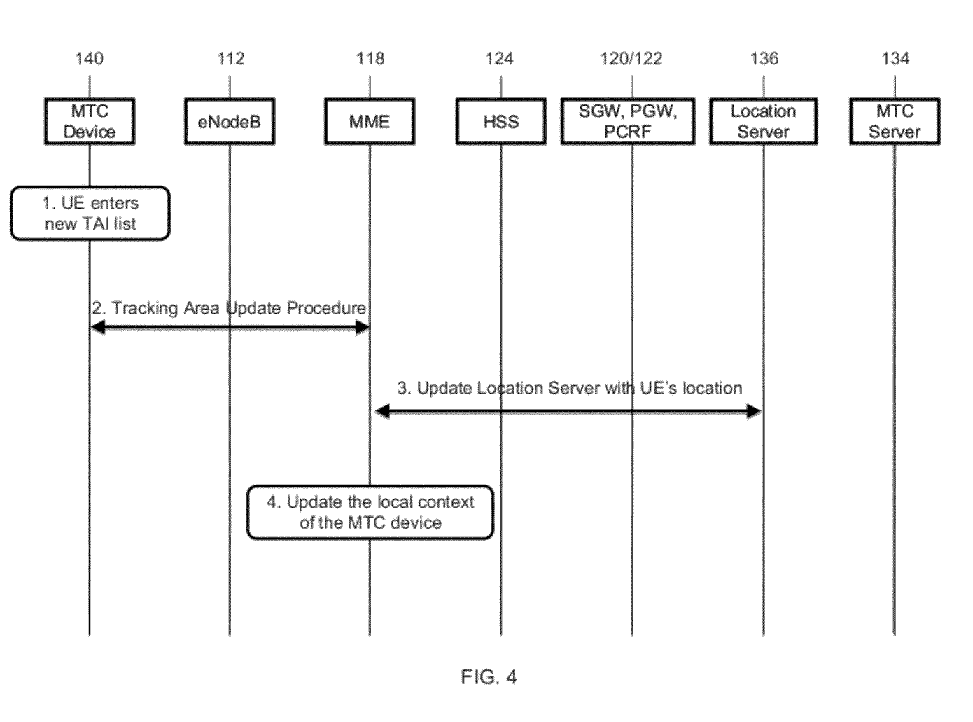

FIG. 4 illustrates a flow diagram for providing mobility to an idle MTC device in an LTE network in accordance with certain embodiments, illustrating how a mobility unit handles a location update for an idle MTC device and updates the location information at the location server. In step 1, an idle MTC device 140 enters a new location identity list, which can include a tracking area identity (TAI) list. Entering a new location identity list can trigger the MTC device 140 to initiate a location update. In step 2, the MTC device 140 sends a location update request message to the MME 118. The location update request message can initiate a location update procedure. The location update request message can include a tracking area update (TAU) request message and the location update procedure can include a TAU procedure. The MME 118 is capable of executing the TAU procedure with the MTC device 140 without any support from SGW/PGW 120 and PCRF 122 since the TAU procedure does not involve communicating with the core network and the MME 118 maintains the mobility information for the idle MTC device 140.

In step 3, the MME 118 can communicate with the location server 136 to update the MTC device's current location in the location server 136. The location server 136 can be integrated with the MTC server 134, so updating the location information at the location server 136 can automatically update the location information at the MTC server 134. In certain embodiments, step 3 is optional. This step is performed when the application hosted at the MTC server 134 needs accurate location information of the MTC device 140. In some cases, certain events may trigger the handover of the MTC device 140 from the serving MME to a new MME. In such cases, the serving MME can inform the new MME to use the location server 136 that the serving MME was using. Furthermore, the serving MME can pass MTC context information to the new MME. The MTC context information can include the MM context and the MTC device indicator. The MTC device indicator can indicate that the MTC device 140 is a MTC device type and that the MTC device is configured for low priority NAS signaling. The new MME can use the received MTC context information to recognize that the handed-over device is a MTC device type and treat the handed-over device accordingly. If the MME 118 serving the MTC device 140 has changed, the MME 118 can also update the binding information stored in the location server 136. In step 4, the MME 118 can update the local context of the MTC device 140 to maintain new location information associated with the idle MTC device 140.

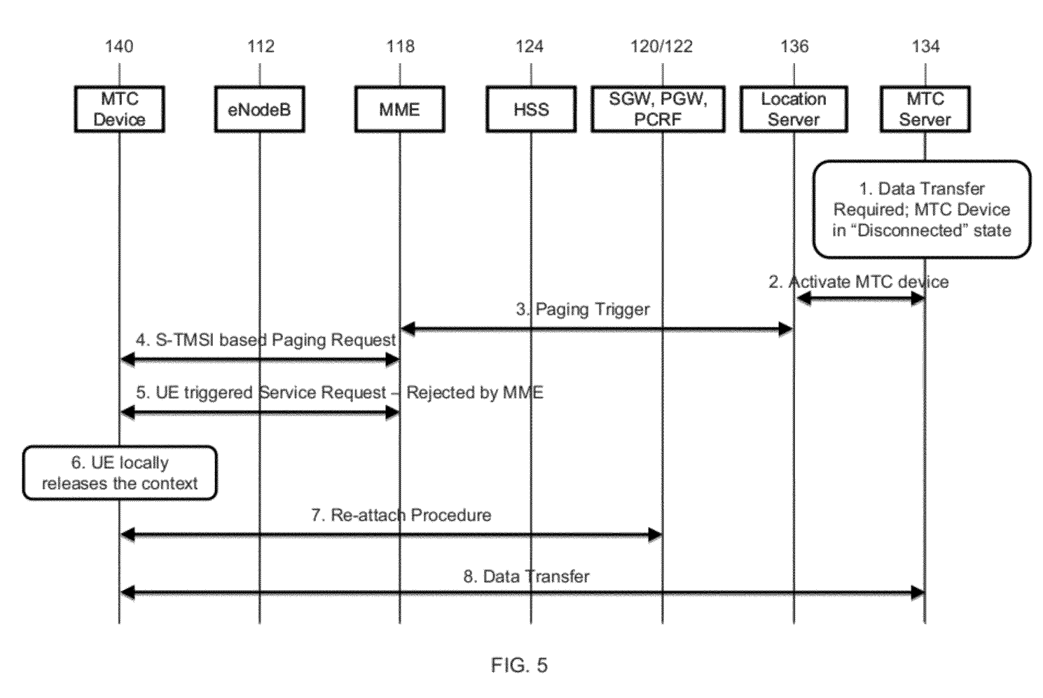

In accordance with certain embodiments, if an MTC server decides to communicate with an idle MTC device, the MTC server can poll the idle MTC device through the MME to re-attach the idle MTC device to the network and initiate data communications. FIG. 5 illustrates a message flow for polling an idle MTC device from an MTC server in accordance with certain embodiments. In step 1, an MTC server 134 decides to poll one of the idle MTC devices associated with the MTC server. The MTC server 134 can poll the idle MTC device 140 at every predefined time interval using a timer and a threshold, or whenever the application hosted on the MTC server 134 desires a data fetch from the MTC device 140. To initiate data communication between the MTC server 134 and the idle MTC device 140, the MTC server 134 can send an activation message to the location server 136 in step 2. The activation message can include an identification of the idle MTC device 140 so that the location server 136 can find the address of the MME 118 serving the idle MTC device 140. In step 3, in response to receiving the activation message, the location server 136 can identify the MME 118 serving the idle MTC device 140 and send a paging trigger message to the identified serving MME 118. The paging trigger message can cause the serving MME 118 to send a paging request message to the idle MTC device 140. The paging trigger message can include the identification of the idle MTC device 140.

In step 4, in response to receiving the paging trigger message, the serving MME 118 sends a paging request message to the idle MTC device 140. The MME 118 can identify the idle MTC device 140 using the identification of the idle MTC device 140 received from the location server 136. Because the MTC device 140 is idle and does not have an active session, the MME 118 might not maintain an active EPS session management (ESM) context for the MTC device 140. Therefore, the MME 118 can send a paging request message to the MTC device 140 using a temporary device identifier. The MME 118 maintains the MM context of the MTC device 140, therefore the MME 118 also maintains a Globally Unique Temporary Identity (GUTI) dedicated to the MTC device 140. The MME 118 can use the GUTI of the device to derive a temporary device identifier. In particular, the MME 118 can derive a system architecture evolution (SAE)-temporary mobile subscriber identity (S-TMSI) from the GUTI. The MME 118 can use the S-TMSI to send a paging request message to the MTC device 140, even if the MME 118 does not have an active ESM context for the MTC device 140.

In step 5, upon receiving the S-TMSI based paging request from the MME 118, the paged MTC device 140 can send a service request message to the MME 118 to initiate a service request procedure. Since the MME 118 does not maintain an active ESM context of the paged MTC device 140, the MME 118 cannot accept the service request from the MTC device 140. Therefore, the MME 118 can respond to the MTC device 140 with a service rejection message, which can indicate that the service request is rejected because the MTC device 140 is implicitly detached from the network. In this message, the MME 118 can also request that the MTC device 140 re-attaches to the network before requesting for service. In step 6, upon receiving the service rejection message, the MTC device 140 can release any context locally and enter a EMM De-registered state.

In step 7, after releasing all the local context, the MTC device 140 can initiate a re-attach procedure. This re-attach procedure can be different from the initial attach procedure detailed in FIG. 2. When the MTC device 140 is initially powered on, as in FIG. 2, the MTC device 140 may not have a temporary identifier to be used in the attach procedure. So in FIG. 2, the MTC device 140 would use an international mobility subscriber identity (IMSI) during the E-UTRAN initial attach. However, for the re-attach procedure, because the MTC device 140 has received a temporary device identifier S-TMSI from the MME 118 in step 4, the MTC device 140 can use the S-TMSI to attach to the network. The re-attach procedure can create a new ESM context in all access network nodes and can allocate a new IP address to the MTC device 140. In step 7, the MTC server 134 can identify the MTC device 140 as “connected.” The MTC device 140 can now accommodate data communication with the MTC server 134.

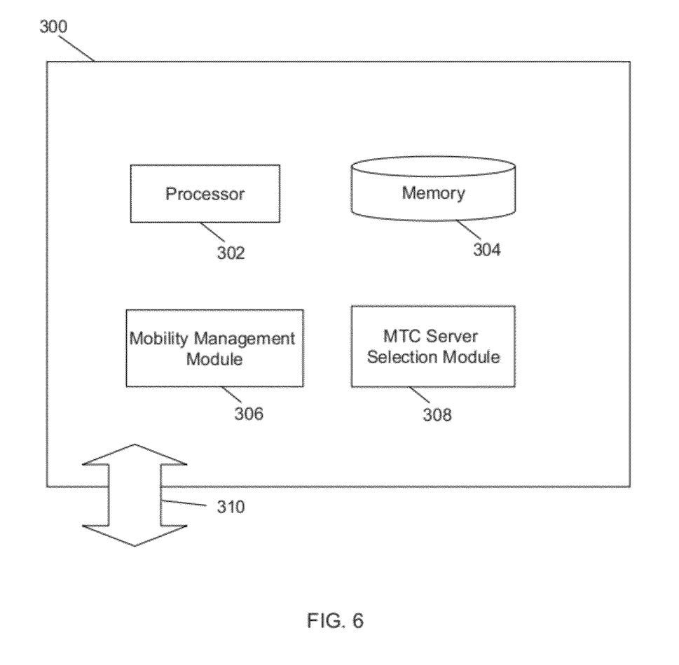

FIG. 6 illustrates a logical view of a mobility unit 300 in accordance with certain embodiments. The mobility unit 300 can include a processor 302, a memory 304, a mobility management module 306, a location server selection module 308, and an interface 310.

A mobility management module 306 can provide mobility to MTC devices even when MTC devices are idle. In particular, the mobility management module 306 can be configured to use mobility information, such as mobility management (MM) context and subscription information, associated with idle MTC devices to support tracking area update (TAU) procedures for idle MTC devices. The MM context can include parameters of the IP bearer service and network internal routing information. The mobility information can be stored in the memory 304 such as a computer readable medium, a programmable read only memory (PROM), or flash memory, and can be accessed by the mobility management module 306. The mobility management module 306 can also be configured to maintain location information of the idle MTC devices. The mobility management module 306 can also send a location update message to a location server to trigger the location server to update the location information of the idle MTC devices. In addition, the mobility management module 306 can be configured to send a paging request message to one or more idle MTC devices to cause one or more idle MTC devices to re-attach to the network. The paging request message can be addressed to the MTC devices using a temporary device identifier, including a S-TMSI. The mobility management module 306 can also maintain a tracking area update (TAU) timer for each mobile device associated with the mobility unit 300. When the TAU timer reaches a threshold, the mobility management module 306 can initiate a TAU procedure for the corresponding mobile device. The mobility management module 306 can be implemented in software using the memory 304 such as a computer readable medium, a programmable read only memory (PROM), or flash memory. The software can run on a processor 302 that executes instructions or computer code. The mobility management module 306 may also be implemented in hardware using an application specific integrated circuit (ASIC), programmable logic array (PLA), or any other integrated circuit.

A location server selection module 308 can select a location server for a newly attached MTC device. The location server selection module 308 is configured to select a location server based on one or more of the following factors: (1) the subscription information, the MTC device's location information, and the locally configured policy, (2) the number of MTC devices attached to the location server, (3) the MTC device subscription information received from a HSS, (4) a local configuration information, or (5) a query to the DNS server serving the MTC device. The location server selection module 308 can be implemented in software using memory 304 such as a computer readable medium, a programmable read only memory (PROM), or flash memory. The software can run on a processor 302 that executes instructions or computer code. The location server selection module 308 may also be implemented in hardware using an application specific integrated circuit (ASIC), programmable logic array (PLA), or any other integrated circuit.

An interface 310 can provide an input and/or output mechanism to communicate with other network devices. The interface 310 can provide communication with MTC devices and location servers as well as other core network nodes to send and receive control data. The interface 310 can be implemented in hardware to send and receive signals in a variety of mediums, such as optical, copper, and wireless, and in a number of different protocols some of which may be non-transient.

### User Equipment and Mobility Unit

As mentioned above, an MTC device can be a traditional LTE user equipment. The user equipment can communicate with a plurality of radio access networks using a plurality of access technologies and with wired communication networks. The user equipment can be a smart phone offering advanced capabilities such as word processing, web browsing, gaming, e-book capabilities, an operating system, and a full keyboard. The user equipment may run an operating system such as Symbian OS, iPhone OS, RIM's Blackberry, Windows Mobile, Linux, Palm WebOS, and Android. The screen may be a touch screen that can be used to input data to the mobile device and the screen can be used instead of the full keyboard. The user equipment may have the capability to run applications or communicate with applications that are provided by servers in the communication network. The user equipment can receive updates and other information from these applications on the network.

The user equipment also encompasses many other devices such as televisions (TVs), video projectors, set-top boxes or set-top units, digital video recorders (DVR), computers, netbooks, laptops, GPS navigation systems, heat sensors, vibration sensors, electrostatic sensors, RFIDs, and any other audio/visual equipment that can communicate with a network. The user equipment can also keep global positioning coordinates, profile information, or other location information in its stack or memory. The user equipment can have a memory such as a computer readable medium, flash memory, a magnetic disk drive, an optical drive, a programmable read-only memory (PROM), and/or a read-only memory (ROM). The user equipment can be configured with one or more processors that process instructions and run software that may be stored in memory. The processor can also communicate with the memory and interfaces to communicate with other devices. The processor can be any applicable processor such as a system-on-a-chip that combines a CPU, an application processor, and flash memory. The interfaces can be implemented in hardware or software. The interfaces can be used to receive both data and control information from the network as well as local sources, such as a remote control to a television. The user equipment can also provide a variety of user interfaces such as a keyboard, a touch screen, a trackball, a touch pad, a mouse, a universal serial bus (USB) port, a parallel port, a serial port, and/or Bluetooth port. The user equipment may also include speakers and a display device in some embodiments.

In accordance with certain embodiments, an unmodified evolved packet system (EPS) can support M2M communication by enhancing UEs or MTC devices. An MTC device can be configured to use EPS resources by activating PDN connections only when the MTC device intends to communicate with the MTC server. Once the MTC device finishes communicating with the MTC server, the MTC device can automatically detach itself from the EPS. Therefore, the EPS does not unnecessarily reserve network resources for the detached MTC device. These enhancements can remain transparent to the EPS: no special handling is necessary from the EPS. When many MTC devices communicate with the MTC server simultaneously, the network can become congested. The network can implement appropriate communication policies to circumvent such network congestions. For example, if the network is close to becoming congested or overloaded, the network can stop the data transfer from one or more of the MTC devices, until the network can accommodate more data transfer.

The mobility unit described above is implemented in a network device in some embodiments. This network device can implement multiple and different integrated functionalities. In some embodiments, one or more of the following functionalities can be implemented on the network device including a security gateway (SeGW), an access gateway, a Gateway General packet radio service Serving Node (GGSN), a serving GPRS support node (SGSN), a packet data inter-working function (PDIF), an access service network gateway (ASNGW), a User Plane Entity (UPE), an IP Gateway, a session initiation protocol (SIP) server, a proxy-call session control function (P-CSCF), and an interrogating-call session control function (I-CSCF), a serving gateway (SGW), and a packet data network gateway (PDN GW), a mobility management entity (MME), a mobility access gateway (MAG), an HRPD serving gateway (HSGW), a local mobility anchor (LMA), a packet data serving node (PDSN), a foreign agent (FA), and/or home agent (HA).

In certain embodiments, the functionalities are provided by a combination of hardware and software in the network device. General purpose hardware can be configured in the network device to provide one or more of these specialized functionalities. The gateway can also support sessions originated from a Femto base station, which would connect to the gateway using a broadband network. A person or corporation may use a Femto base station in a home or business to support one or more mobile devices. The gateway can provide trigger based traffic management during a handoff from a Femto base station to a macro base station, while maintain traffic management for the mobile device. The offload gateway can be implemented as any combination of the following including an xGSN, an xGW, an xGW-SGW, and an xGW-PGW.

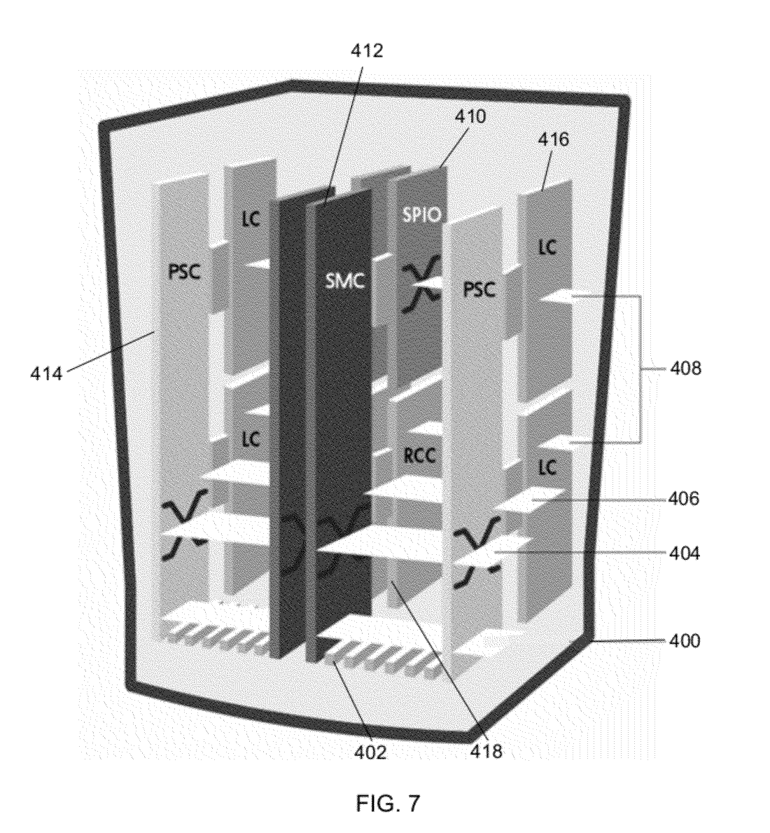

In some embodiments the network device is implemented using a collection of integrated circuit boards or cards. These cards include input/output interfaces for communication amongst each other, at least one processor for executing instructions and running modules that are stored in memory, and memory for storing data. The features of a network device that implements a gateway, in accordance with some embodiments, are further described below. FIG. 7 illustrates the implementation of a network device in accordance with some embodiments. The network device 400 includes slots 402 for loading application cards and line cards. A midplane can be used in the network device to provide intra-network device communications, power connections, and transport paths between the various installed cards. The midplane can include buses such as a switch fabric 404, a control bus 406, a system management bus, a redundancy bus 408, and a time division multiplex (TDM) bus. The switch fabric 404 is an IP-based transport path for user data throughout the network device implemented by establishing inter-card communications between application cards and line cards. The control bus 406 interconnects the control and management processors within the network device. The network device management bus provides management of system functions such as supplying power, monitoring temperatures, board status, data path errors, card resets, and other failover features. The redundancy bus 408 provides transportation of user data and redundancy links in the event of hardware failures. The TDM bus provides support for voice services on the system.

The network device supports at least four types of application cards: a switch processor I/O card (SPIO) 410, a system management card (SMC) 412, a packet service card (PSC) 414, and a packet accelerator card (not shown). Other cards used in the network device include line cards 466 and redundant crossbar cards (RCC) 418. The line cards 416, when loaded in the network device, provide input/output connectivity to the network and other devices, as well as redundancy connections. The line cards 416 include interfaces to the network through Ethernet, Fiber Optic, and the other communication mediums. The redundant crossbar card (RCC) 418 includes a non-blocking crossbar and connections to each of the cards in the network device. This allows a redundant connection to be made through the redundant crossbar card 418 from any one card to any other card in the network device. The SPIO card 410 serves as a controller of the network device and is responsible for such things as initializing the network device and loading software configurations onto other cards in the network device.

The system management card (SMC) 412 and switch processor card (not shown) are system control and management cards for managing and controlling other cards in the network device. The packet accelerator card (PAC) and packet service card (PSC) 414 provide packet processing, context processing capabilities, and forwarding capabilities among other things. The PAC and PSC 414 perform packet-processing operations through the use of control processors and a network processing unit. The network processing unit determines packet processing requirements; receives and transmits user data frames to/from various physical interfaces; makes IP forwarding decisions; implements packet filtering, flow insertion, deletion, and modification; performs traffic management and traffic engineering; modifies/adds/strips packet headers; and manages line card ports and internal packet transportation. The control processors, also located on the packet accelerator card, provide packet-based user service processing.

The operating system software can be based on a Linux software kernel and run specific applications in the network device such as monitoring tasks and providing protocol stacks. The software allows network device resources to be allocated separately for control and data paths. For example, certain packet accelerator cards and packet services cards can be dedicated to performing routing or security control functions, while other packet accelerator cards/packet services cards are dedicated to processing user session traffic. As network requirements change, hardware resources can be dynamically deployed to meet the requirements in some embodiments. The system can be virtualized to support multiple logical instances of services, such as technology functions (e.g., a SeGW PGW, SGW, MME, HSGW, PDSN, ASNGW, PDIF, HA, or GGSN).

The network device's software can be divided into a series of tasks that perform specific functions. These tasks communicate with each other as needed to share control and data information throughout the network device. A task is a software process that performs a specific function related to system control or session processing. Three types of tasks operate within the network device in some embodiments: critical tasks, controller tasks, and manager tasks. The critical tasks control functions that relate to the network device's ability to process calls such as network device initialization, error detection, and recovery tasks. The controller tasks mask the distributed nature of the software from the user and perform tasks such as monitor the state of subordinate manager(s), provide for intra-manager communication within the same subsystem, and enable inter-subsystem communication by communicating with controller(s) belonging to other subsystems. The manager tasks can control system resources and maintain logical mappings between system resources.

Individual tasks that run on processors in the application cards can be divided into subsystems. A subsystem is a software element that either performs a specific task or is a culmination of multiple other tasks. A single subsystem can include critical tasks, controller tasks, and manager tasks. Some of the subsystems that can run on a network device include a system initiation task subsystem, a high availability task subsystem, a recovery control task subsystem, a shared configuration task subsystem, a resource management subsystem, a virtual private network subsystem, a network processing unit subsystem, a card/slot/port subsystem, and a session subsystem.

The system initiation task subsystem is responsible for starting a set of initial tasks at system startup and providing individual tasks as needed. The high availability task subsystem works in conjunction with the recovery control task subsystem to maintain the operational state of the network device by monitoring the various software and hardware components of the network device. Recovery control task subsystem is responsible for executing a recovery action for failures that occur in the network device and receives recovery actions from the high availability task subsystem. Processing tasks are distributed into multiple instances running in parallel so if an unrecoverable software fault occurs, the entire processing capabilities for that task are not lost. User session processes can be sub-grouped into collections of sessions so that if a problem is encountered in one sub-group users in another sub-group will not be affected by that problem.

The architecture also allows check-pointing of processes, which is a mechanism to protect the system against any critical software processes that may fail. The self-healing attributes of the software architecture protects the system by anticipating failures and instantly spawning mirror processes locally or across card boundaries to continue the operation with little or no disruption of service. This unique architecture allows the system to perform at the highest level of resiliency and protects the user's data sessions while ensuring complete accounting data integrity.

Shared configuration task subsystem provides the network device with an ability to set, retrieve, and receive notification of network device configuration parameter changes and is responsible for storing configuration data for the applications running within the network device. A resource management subsystem is responsible for assigning resources (e.g., processor and memory capabilities) to tasks and for monitoring the task's use of the resources.

Virtual private network (VPN) subsystem manages the administrative and operational aspects of VPN-related entities in the network device, which include creating separate VPN contexts, starting IP services within a VPN context, managing IP pools and subscriber IP addresses, and distributing the IP flow information within a VPN context. In some embodiments, within the network device, IP operations are done within specific VPN contexts. The network processing unit subsystem is responsible for many of the functions listed above for the network processing unit. The card/slot/port subsystem is responsible for coordinating the events that occur relating to card activity such as discovery and configuration of ports on newly inserted cards and determining how line cards map to application cards.

The session subsystem is responsible for processing and monitoring a mobile subscriber's data flows in some embodiments. Session processing tasks for mobile data communications include: S1/S5/S8 interface termination for LTE networks, A10/A11 interface termination for CDMA networks, GSM tunneling protocol (GTP) termination for GPRS and/or UMTS networks, asynchronous PPP processing, IPsec, packet filtering, packet scheduling, Diffserv codepoint marking, statistics gathering, IP forwarding, and AAA services, for example. Responsibility for each of these items can be distributed across subordinate tasks (called managers) to provide for more efficient processing and greater redundancy. A separate session controller task serves as an integrated control node to regulate and monitor the managers and to communicate with the other active subsystem. The session subsystem also manages specialized user data processing such as payload transformation, filtering, statistics collection, policing, and scheduling.

In providing emulation, as MIPv4 is received from a mobile device, the session subsystem can setup a MIPv4 termination and setup a PMIPv6 session towards the core network. A session manager can track the mapping of the sessions and processing to provide the emulation and inter-working between the networks. A database can also be used to map information between the sessions, and store, for example, NAI, HoA, AE information in some embodiments.

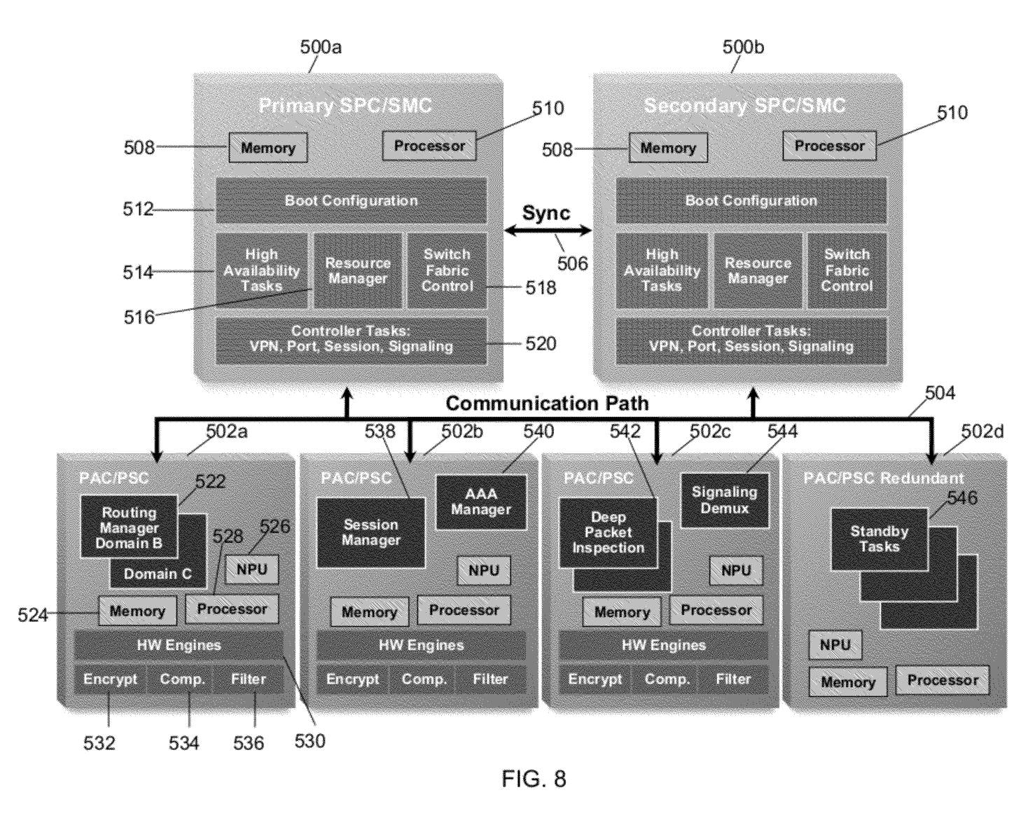

The network device allows system resources to be allocated separately for control and data paths. For example, certain PACs/PSCs could be dedicated to performing routing or security control functions while other PACs/PSCs are dedicated to processing user session traffic. As network requirements grow and call models change, hardware resources can be added to accommodate processes, such as encryption, packet filtering, etc., that require more processing power. FIG. 8 illustrates a logical view of the software architecture of a network device in accordance with certain embodiments. As shown, the software and hardware can be distributed within the network device and across different circuit boards, processors, and memory. FIG. 8 includes a primary switch processor card (SPC)/system management card (SMC) 500a, a secondary SPC/SMC 500b, PAC/PSC 502a-502d, a communication path 504, and a synchronization path 506. The SPC/SMC 500 include a memory 508, a processor 510, a boot configuration 512, high availability tasks 514, resource manager 516, switch fabric control 518, and controller tasks 520.

The SPC/SMC 500 manage and control the network device including the other cards in the network device. The SPC/SMC 500 can be configured in a primary and secondary arrangement that provides redundancy and failsafe protection. The modules or tasks running on the SPC/SMC 500 are related to network device wide control and management. The boot configuration task 512 includes information for starting up and testing the network device. The network device can also be configured to startup in different configurations and providing different implementations. These can include which functionalities and services are capable of running on the SPC/SMC 500. The high availability task 514 maintains the operational state of the network device by monitoring the device and managing recovery efforts to avoid disruption of service. The resource manager tracks and assigns the available resources for sessions and demands on the network device. This can include load balancing among different processors and tasks running on the network device. Processes can be distributed across the system to fit the needs of the network model and specific process requirements. For example, most tasks can be configured to execute on SPC/SMC 500 or a PAC/PSC 502, while some processor intensive tasks can also be performed across multiple PACs/PSCs to utilize multiple CPU resources. Distribution of these tasks is invisible to the user. The switch fabric control 518 controls the communication paths in the network device. The controller tasks module 520 can manage the tasks among the resources of the networks to provide, for example, VPN services, assign ports, and create, delete, and modify sessions for user equipment.

The PAC/PSC 502 are high-speed processing cards that are designed for packet processing and the tasks involved with providing various network functionalities on the network device. The PAC/PSC 502 include a memory 524, a network processing unit (NPU) 526, a processor 528, a hardware engine 530, an encryption component 532, a compression component 534, and a filter component 536. Hardware engines 530 can be deployed with the card to support parallel distributed processing for compression, classification traffic scheduling, forwarding, packet filtering, and statistics compilations. The components can provide specialize processing that can be done more efficiently than using a general processor in some embodiments.

Each PAC/PSC 502 is capable of supporting multiple contexts. The PAC/PSC 502 are also capable of running a variety of tasks or modules. PAC/PSC 502a provides routing managers 522 with each covering routing of a different domain. PAC/PSC 502b provides a session manager 538 and an AAA manager 540. The session manager 538 manages one or more sessions that correspond to one or more user equipment. A session allows a user equipment to communicate with the network for voice calls and data. The AAA manager 540 manages accounting, authentication, and authorization with an AAA server in the network. PAC/PSC 502 provides a deep packet inspection task 542 and a signaling demux 544. The deep packet inspection task 542 provides inspection of packet information beyond layer 4 for use and analysis by the network device. The signaling demux 544 can provide scalability of services in combination with other modules. PAC/PSC 502d provides redundancy through standby tasks 546. Standby tasks 546 store state information and other task information so that the standby task can immediately replace an active task if a card fails or if there is a scheduled event to remove a card.

In some embodiments, the software needed for implementing a process or a database includes a high level procedural or an object-orientated language such as C, C++, C#, Java, or Perl. The software may also be implemented in assembly language if desired. Packet processing implemented in a network device can include any processing determined by the context. For example, packet processing may involve high-level data link control (HDLC) framing, header compression, and/or encryption. In certain embodiments, the software is stored on a storage medium or device such as read-only memory (ROM), programmable-read-only memory (PROM), electrically erasable programmable-read-only memory (EEPROM), flash memory, or a magnetic disk that is readable by a general or special purpose-processing unit to perforin the processes described in this document. The processors can include any microprocessor (single or multiple core), system on chip (SoC), microcontroller, digital signal processor (DSP), graphics processing unit (GPU), or any other integrated circuit capable of processing instructions such as an x86 microprocessor.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Other embodiments are within the following claims. For example, the mobility unit such as a mobility management entity (MME) can be combined or co-located with the serving gateway (SGW).

We claim:

1. A method comprising:
maintaining mobility information at a Mobility Management Entity (MME) in a communication network, wherein the MME is associated with at least one mobile device including a first mobile device and the mobility information includes mobility management context associated with the first mobile device;
initiating a network session termination procedure to cause a release of resources associated with the first mobile device;
in response to a location update request message from the first mobile device, executing a location update procedure using the mobility information associated with the first mobile device and maintaining location information of the first mobile device;
receiving a paging trigger message initiated by an application server, wherein the paging trigger message includes an identification of the first mobile device to indicate that the first mobile device be paged; and
sending a paging request message to the first mobile device to cause the first mobile device to attach to the communication network to accommodate data communication with the application server.

2. The method of claim 1, further comprising analyzing subscription information associated with the first mobile device in order to select a location server for the first mobile device, wherein the subscription information is received from a home subscriber server (HSS).

3. The method of claim 1, further comprising receiving a service request message from the first mobile device and sending a service rejection message to the first mobile device, wherein the service rejection message indicates that the first mobile device be attached to the communication network before requesting for service.

4. The method of claim 1, wherein the paging request message includes a system architecture evolution-temporary mobile subscriber identity (S-TMSI) of the first mobile device assigned by the MME.

5. The method of claim 1, wherein the mobile device includes a machine-type communication (MTC) device and the application server includes an MTC server.

6. The method of claim 1, wherein the network session termination procedure is initiated in response to an expiration of a UE inactivity timer indicating an end of data communication between the first mobile device and the application server.

7. The method of claim 1, further comprising sending a message to a location server to cause the location server to update location information of the first mobile device, wherein the location server is associated with the application server.

8. The method of claim 7, wherein the location server is configured to maintain a binding information indicating that the MME is serving the first mobile device.

9. The method of claim 8, wherein the location server is integrated with the application server to provide an integrated service to the first mobile device.

10. An MME comprising:
an interface that is configured to provide communication with a location server and a mobile device;
a memory that is configured to maintain mobility information associated with the mobile device;
a module that is configured to execute a tracking area update (TAU) procedure with the mobile device by accessing the mobility information associated with the mobile device, initiate a network session termination procedure to cause a release of communication resources associated with the mobile device, and send a paging request message to the mobile device to cause the mobile device to attach to a communication network.

11. The MME of claim 10, wherein the module is further configured to analyze subscription information associated with the first mobile device in order to select a location server for the first mobile device, wherein the subscription information is received from a home subscriber server (HSS).

12. The MME of claim 10, wherein the module is further configured to receive a paging trigger message initiated by an application server, the paging trigger message indicating that the mobile device be paged.

13. The MME of claim 12, wherein the paging request message includes a system architecture evolution-temporary mobile subscriber identity (S-TMSI) of the mobile device assigned by the MME.

14. The MME of claim 10, wherein the module is further configured to send a message to the location server to cause the location server to update location information associated with the mobile device.

15. The MME of claim 10, wherein the location server is configured to maintain a binding information indicating that the MME is serving the mobile device.

16. The MME of claim 10, wherein the network session termination procedure is initiated in response to an expiration of a timer indicating an end of data communication between the first mobile device and the application server.

17. The MME of claim 10, wherein the mobile device executing the TAU procedure with the module is in an idle state.

18. Logic encoded on one or more tangible media for execution and when executed operable to:
maintain mobility information in a communication network, wherein the mobility information includes mobility management context associated with a mobile device;
initiate a network session termination procedure to trigger release of communication resources associated with the mobile device;
in response to a location update request message from the mobile device, execute a location update procedure using the mobility information associated with the mobile device;
maintain location information of the mobile device;
receive a paging trigger message initiated by an application server, wherein the paging trigger message includes an identification of the mobile device indicating that the mobile device be paged; and
send a paging request message to the mobile device to cause the mobile device to attach to the communication network and to cause the mobile device to accommodate data communication with the application server.

19. The logic of claim 18, wherein the paging request message includes a system architecture evolution-temporary mobile subscriber identity (S-TMSI) of the mobile device assigned by an MME.

20. The logic of claim 18, further operable to send a message to a location server to cause the location server to update location information of the mobile device.
